(19) United States
(12) Patent Application Publication
(10) Pub. No.: US 2013/0251080 A1
(43) Pub. Date: Sep. 26, 2013

(54) LOW NOISE AMPLIFIER

(71) Applicant: Electronics and Telecommunications Research Institute, (US)

(72) Inventor: Kunal Jayant Dadia, Daejeon (KR)

(73) Assignee: Electronics and Telecommunications Research Institute, Daejeon (KR)

(21) Appl. No.: 13/830,581

(22) Filed: Mar. 14, 2013

(30) Foreign Application Priority Data
Mar. 20, 2012 (KR) 10-2012-0028503

(51) Int. Cl. H04L 27/00

(52) U.S. Cl. CPC H04L 27/0002
USPC 375/349

(57) ABSTRACT

A low noise amplifier for use in a front end includes a multiple-input interference canceller configured to receive a plurality of input signals, and output a signal from which an interference component is removed. The multiple-input interference canceller includes a plurality of gain control blocks configured to receive each of the input signals, and perform gain control, and a coupling block configured to couple output signals of the gain control blocks.

### CROSS-REFERENCE TO RELATED APPLICATION

The present application claims priority to Korean patent application number 10-2012-0028503 filed on Mar. 20, 2012, which is incorporated by reference in its entirety.

### BACKGROUND OF THE INVENTION

The present invention relates to a Low Noise Amplifier (LNA), and more particularly to a low noise amplifier (LNA) configured to receive multiple-band signals that are used in a front end so as to remove interference components from the received signal.

The related art of the present invention is disclosed in Korean Patent Laid-open Publication No. 2011-0046221 (published on May 4, 2011).

The LNA is mounted to a reception end of a radio frequency (RF) transmission/reception system such that it can amplify the RF signal received at the reception end. The LNA may be implemented as an integration circuit, and an LNA integration circuit (IC) apparatus includes an input port and an output port.

A variety of technologies can be used to remove interference components from the front end. For example, some technologies aim to improve linearity using designing a mixer based on embedded transmission (Tx) filtering. In another example, other technology may be a block interfering technology based on feed-forward cancellation techniques. Most representative technologies require frequency conversion, and thus require many more hardware resources for such frequency conversion, such that much more noise may be unavoidably generated in the RF front end.

In addition, there are a variety of modified LNA (such as a common gate LNA and a feedback LNA) capable of improving LNA linearity and including a filter so as to prevent the occurrence of jammers. Although the above-mentioned technologies reduce hardware resources, improve a noise figure, reduce not only jammer level but also third order terms, they are not considered to be effective and independent technologies in terms of the degree of interference restriction.

A transceiver can also utilize another technology that can generate adaptive nulls within an interference band such that it can reduce Tx leakage using feed-forward cancellation. FIG. 1 is a block diagram illustrating a general leakage-signal canceller including a duplexer.

Referring to FIG. 1, the cancellation block 13 receives power from a power amplifier (not shown) through a coupler 11, adjusts the phase and magnitude of the power of a transmitter in response to the phase and magnitude of Tx leakage caused by a duplexer 12, and removes the leakage power through a power adder 14 acting as a coupler connected to the cancellation block 13 through a substitute path. In this case, the power amplifier is an independent entity for use in a general transceiver and is implemented as an off-chip, such that the presence of a first coupler 11 is regarded as appropriate. The first coupler 11 is adapted to receive power from a main path without affecting transmission (Tx) power radiated through an antenna.

However, in order to implement the cancellation block 13 in a single chip, it is necessary to remove the power adder 14 acting as a second coupler contained in the output end. If an off-chip power-adding coupler is removed from the transmitter, the available space is reduced in size, resulting in the implementation of a smaller-sized chip. A substitute of such coupler needs to be implemented as an on-chip.

A role of such substitute is shown in FIG. 2. FIG. 2 is a block diagram illustrating a leakage signal canceller (acting as a low noise adder) including an interference canceller 15 and a duplexer. The interference canceller 15 has the following necessities (1)˜(6).

1) Referring to FIG. 2, the interference canceller 15 is needed for removing Tx leakage caused by insufficient isolation provided by the duplexer 12. In addition, the interference canceller 15 is also needed for transmitting a desired signal having Tx spectrum in a lossless transmission manner.

2) Therefore, the above-mentioned interference canceller 15 is helpful to remove the Tx leakage signal.

3) The interference canceller 15 is located at an RF front end part located prior to the LNA 16, such that the amount of noise applied to the system through the interference canceller 15 must be very small.

4) In addition, it is necessary for the interference canceller 15 to have high linearity to prevent the occurrence of interferers that cause the system problems generated upon completion of signal processing of the LNA 16.

5) Deterioration of a desired signal received from the antenna needs to be maintained at a relatively low level.

6) The interference canceller 15 is designed to obtain a desired signal through cancellation of a leakage signal, such that a complete gain matching must be achieved between two different paths directing to the low noise adder 15 at a leakage frequency, and a high gain of a main path must be obtained at a desired frequency.

Therefore, a new technology capable of cancelling (or removing) RF interference is needed, and it is necessary for the interference canceller 15 to be used as a low noise adder that may be helpful to interference cancellation at the RF front end. As a result, a low noise amplifier (LNA) including the interference canceller 15 is needed.

### SUMMARY OF THE INVENTION

Various embodiments of the present invention are directed to providing a low noise amplifier (LNA) that substantially obviates one or more problems due to limitations or disadvantages of the related art. Embodiments of the present invention provide a low noise amplifier (LNA) for use in a front end, which can remove RF interference components without performing frequency conversion, and can solve the necessity of a low noise adder or subtractor as necessary, such that it can receive signals from multiple bands to which low noise is applied, thereby outputting the resultant signal including no interference components.

In accordance with one embodiment, a low noise amplifier for use in a front end includes a multiple-input interference canceller configured to receive a plurality of input signals, and output a signal from which an interference component is removed, wherein the multiple-input interference canceller includes a plurality of gain control blocks configured to receive each of the input signals, and perform gain control, and a coupling block configured to couple output signals of the gain control blocks.

The input signals may be differential or independent signals.

The gain control blocks may have mutually-dependent gain values or independent gain values.

Each of the gain control blocks may include a pull-down unit for pulling down an output terminal in response to each input signal; and a pull-up unit for pulling up the output terminal.

Each gain control block may further include an input potential controller that is connected between an input terminal receiving each input signal and an external power source so as to control potential of an input terminal.

The input potential controller may include a first resistor connected to the external power source; an NMOS diode connected between the first resistor and a ground terminal; and a second resistor connected between the input terminal and a gate terminal of the NMOS diode.

The output terminals of the gain control blocks may be commonly connected to a final output terminal of the multiple-input interference canceller.

Each gain control block may further include a capacitor connected to a gate terminal of the pull-down unit and a ground terminal so as to perform potential maintenance or buffering operation.

The coupling block may be an adder or a subtractor.

### BRIEF DESCRIPTION OF THE DRAWINGS

FIG. 1 is a block diagram illustrating a general leakage-signal canceller including a duplexer.

FIG. 2 is a block diagram illustrating a leakage signal canceller including a duplexer and a low noise adder.

FIG. 3 is a conceptual diagram illustrating a multiple-input interference canceller for use in a low noise amplifier (LNA) according to an embodiment of the present invention.

FIG. 4 is a detailed circuit diagram illustrating a multiple-input interference canceller for use in a low noise amplifier (LNA) according to an embodiment of the present invention.

FIG. 5 is a graph illustrating gain characteristics of gain control blocks contained in the multiple-input interference canceller according to an embodiment of the present invention.

FIG. 6 is a graph illustrating cancellation characteristics of 2-input LNA according to the present invention.

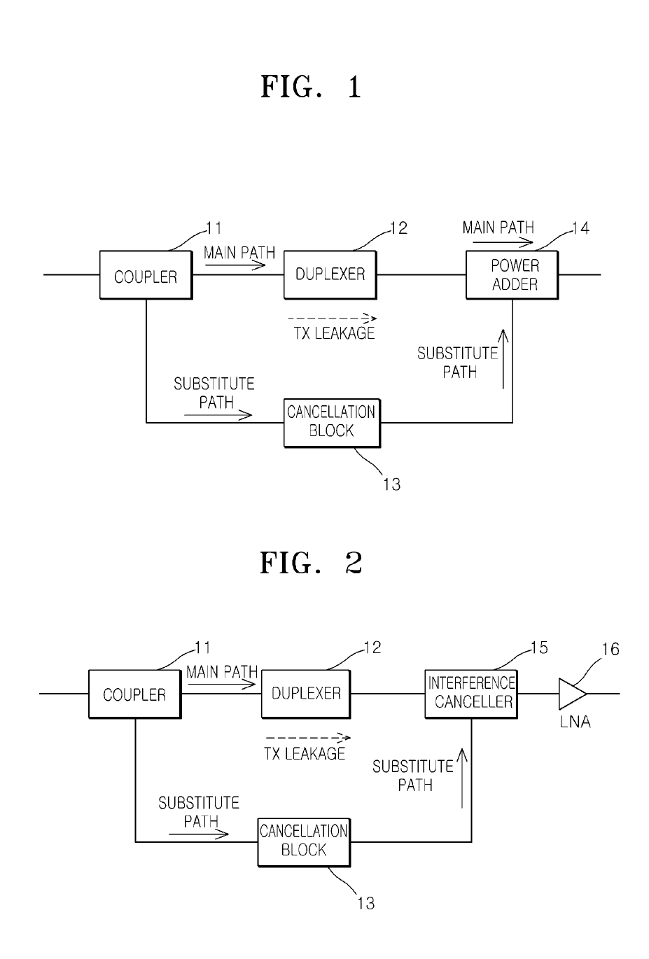

### DESCRIPTION OF SPECIFIC EMBODIMENTS

Reference will now be made in detail to the embodiments of the present invention, examples of which are illustrated in the accompanying drawings. Wherever possible, the same reference numbers will be used throughout the drawings to refer to the same or like parts. In the following description of the present invention, a detailed description of related known configurations or functions incorporated herein will be omitted when it may make the subject matter of the present invention rather unclear.

Throughout the entirety of the specification of the present invention, if it is assumed that a certain part includes a certain component, the term ‘including’ means that a corresponding component may further include other components unless a specific meaning opposed to the corresponding component is written.

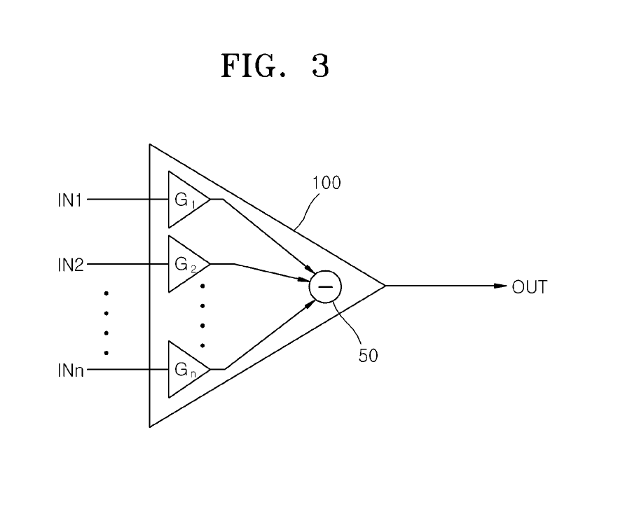

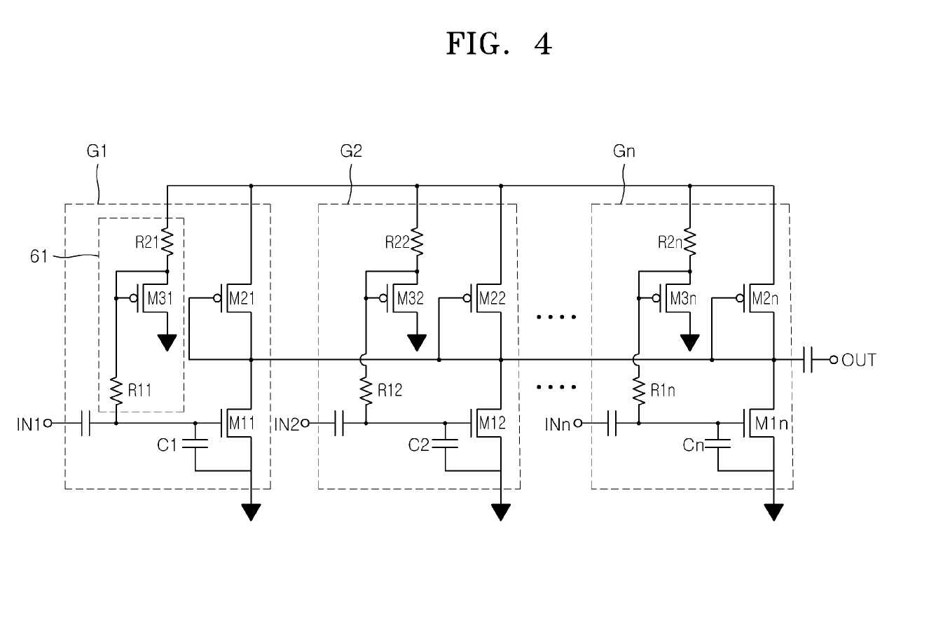

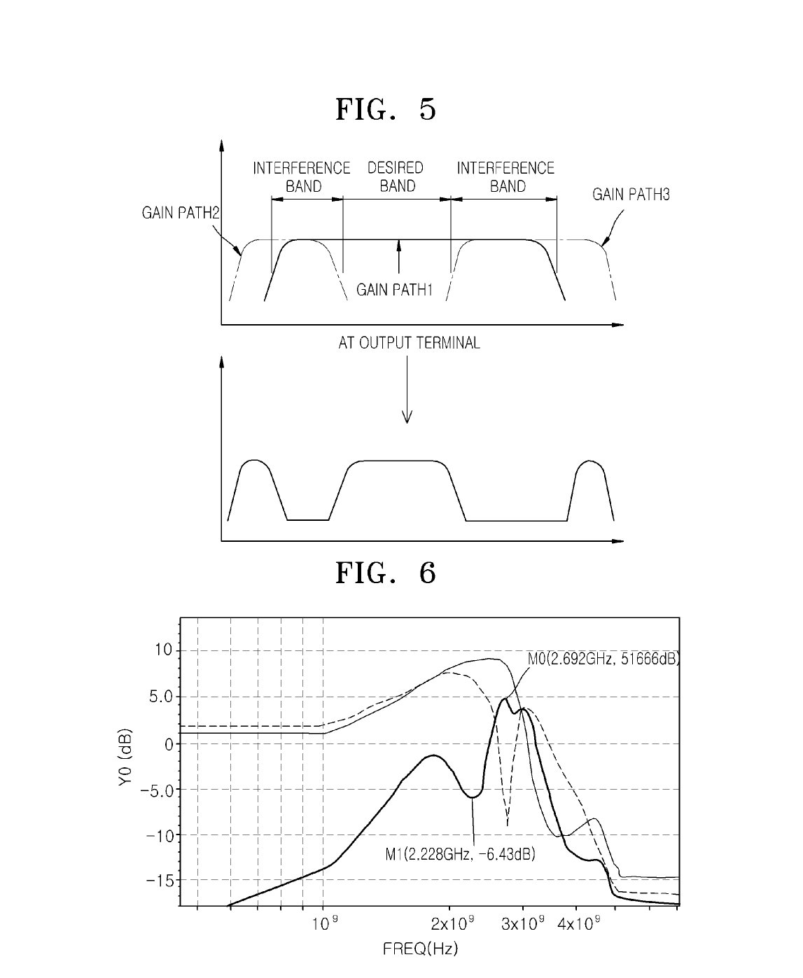

FIG. 3 is a conceptual diagram illustrating a multiple-input interference canceller for use in a low noise amplifier (LNA) according to an embodiment of the present invention. FIG. 4 is a detailed circuit diagram illustrating a multiple-input interference canceller for use in a low noise amplifier (LNA) according to an embodiment of the present invention. FIG. 5 is a graph illustrating gain characteristics of gain control blocks contained in the multiple-input interference canceller according to an embodiment of the present invention. FIG. 6 is a graph illustrating cancellation characteristics of 2-input LNA according to the present invention. Hereinafter, the low noise amplifier (LNA) according to the present invention will be described in detail with reference to the accompanying drawings.

Referring to FIGS. 3 and 4, the LNA according to an embodiment of the present invention includes a multiple-input interference canceller 100 configured to receive a plurality of input signals (IN1˜INn) and output the resultant signal (OUT) having no interference component. The multiple-input interference canceller 100 includes a plurality of gain control blocks (G1˜Gn) for performing gain control upon receiving the plurality of input signals (IN1˜INn), and a coupling block 50 for coupling output signals of the plurality of gain control blocks (G1˜Gn). The gain control blocks (G1˜Gn) may respectively include a plurality of N-type Metal Oxide Semiconductor (NMOS) (M11˜M1n) elements serving as pull-down units so as to pull down an output terminal in response to individual input signals (IN1˜INn); and a plurality of P-type Metal Oxide Semiconductor (PMOS) elements (M21˜M2n) configured to pull up the output terminal.

In addition, each gain control block (G1˜Gn) may further include an input potential controller 61 installed between an input terminal of each input signal (IN1˜INn) and an external power-supply voltage VDD so as to control a potential of the input terminal. The input potential controller 61 may include a first resistor R21 connected to the external power-supply voltage VDD; an NMOS diode M31 connected between the first resistor R21 and a ground terminal; and a second resistor R11 connected between the input terminal and a gate terminal of the NMOS diode M31.

In addition, the gain control blocks (G1˜Gn) may further include capacitors (C1˜Cn) respectively connected between a ground terminal and gate terminals of the NMOS elements (M11˜M1n), such that the capacitors (C1˜Cn) can perform potential maintenance or buffering operation.

Operations of the low noise amplifier (LNA) according to embodiments of the present invention will hereinafter be described with reference to FIGS. 3 to 6.

Referring to FIG. 3, the LNA for use in the front end according to the present invention includes a multiple-input interference canceller 100 for receiving a plurality of input signals (IN1˜INn) and outputting the resultant signals having no interference components. The input signals (IN1˜INn) to be input to the multiple-input interference cancellation 100 are input to the gain control blocks (G1˜Gn), respectively, such that the resultant gain-controlled signals are output from the gain control blocks (G1˜Gn). The coupling block 50 performs addition or subtraction among the resultant gain-controlled signals generated from the gain control blocks (G1˜Gn), such that it outputs the resultant output signal OUT.

In this case, the input signals (IN1˜INn) may be differential or independent signals. In addition, the gain control blocks (G1˜Gn) may have independent gain values or mutually-dependent gain values.

The input signals (IN1˜INn) respectively input to the gain control blocks (G1˜Gn) are gain-controlled in a mutually dependent manner or an independent manner, and addition or subtraction of the gain-controlled signals is performed by the coupling block 50, such that an interference band between signals can be effectively removed.

That is, as shown in FIG. 5, the individual input signals (IN1˜INn) input to the multiple-input interference canceller 100 of the LNA can be adjusted within a desired band, such that each gain control block belonging to each path amplifies each input signal. The gain control blocks (G1˜Gn) may have various gain characteristics shown in FIG. 5. Subtraction or addition of the output signals of the gain control blocks (G1˜Gn) is performed by the coupling block 50 acting as a conceptual current adder. Therefore, bands having the same magnitude and the same phase are removed from the output signal of the multiple-input interference canceller 100, such that the multiple-input interference canceller 100 may be helpful to interference cancellation. In this embodiment, an adder or subtractor may be used as the coupling block 50.

One embodiment of the multiple-input interference canceller 100 will hereinafter be described with reference to FIG. 4.

Referring to FIG. 4, the input signals (IN1˜INn) are input to the gain control blocks (G1˜Gn), respectively. Thus, the input signals (IN1˜INn) are gain-controlled not only by NMOS elements configured to pull down the output terminal but also by PMOS elements (M21˜M2n) configured to pull up the output terminal, such that the resultant gain-controlled signals are output to the output terminal. In more detail, the input signals (IN1˜INn) are gain-controlled through voltage division that is achieved not only by NMOS elements (M11˜M1n) operated in response to the input signals (IN1˜INn) but also by PMOS elements (M21˜M2n) operated in response to the potential of the output terminal, such that the resultant gain-controlled signals are obtained.

In this case, each gain control block (G1˜Gn) may further include an input potential controller 61 connected between an input terminal and an external power-supply voltage VDD so as to control the potential of the input terminal. The input potential controller 61 includes a first resistor R2 connected to the external power-supply voltage VDD, an NMOS diode M31 connected between the first resistor R21 and the ground terminal, and a second resistor R11 connected between the input terminal and a gate terminal of the NMOS diode M31. That is, the potential of the input terminal for receiving the input signals (IN1˜INn) may be controlled by the first resistor R21, the NMOS diode M31 and the second resistor R11 contained in the input potential controller 61, such that the controlled potential can greatly contribute to gain control. On the other hand, according to this embodiment, the gain control blocks (G1˜Gn) include capacitors (C1˜Cn) respectively connected between a ground terminal and gate terminals of the NMOS elements (M11˜M1n), such that the capacitors (C1˜Cn) can perform potential maintenance or buffering operation.

Subsequently, output terminals of the gain control blocks (G1˜Gn) are commonly connected to the resultant output terminal OUT of the multiple-input interference canceller. Through the above-mentioned connection method, the output signals of the gain control blocks (G1˜Gn) are added or subtracted by a conceptual current adder. Bands having the same magnitude and the same phase are removed from the output signal of the multiple-input interference canceller 100, such that the multiple-input interference canceller 100 can completely remove interference components.

FIG. 6 is a graph illustrating cancellation characteristics of 2-input LNA from among the multiple-input LNA according to the embodiments of the present invention. As can be seen from FIG. 6, the 2-input signals have different gains, and pass through a plurality of gain paths tuned to different frequencies. Thereafter, the output signal of each gain path is applied to the adder (or subtractor) acting as the coupling block, and bands having similar magnitudes and similar phase matching can obtain the maximum cancellation effect. Therefore, although the amplitude has a difference of 1 dB at 2.2 GHz, phase characteristics have the best matching rate at 2.2 GHz as compared to that of 1.78 GHz (because of the input matching) at which actual gain matching occurs. Accordingly, it can be recognized that there arises cancellation of 1.5 dB caused by different paths. Simultaneously, the degree of signal cancellation is not high at 2.7 GHz, however the resultant signal of 2.7 GHz shows a gain of 5.2 dB lower than an original gain provided from a first input (Input 1) by a predetermined value of 3 dB.

The low noise amplifier (LNA) including the multiple-input interferer according to the above-mentioned embodiments has at least one of the following effects 1) to 6).

1) Interference Cancellation

Multiple paths are independent of each other, such that interference signals from different paths are matched in magnitude and phase, such that the interference signals can be removed from the output signal, resulting in the implementation of interference cancellation effect. Multiple paths can be adjusted independently and separately, such that they are helpful to remove multiple interferers.

2) Noise Cancellation

Paths are configured to receive the same input noise, such that the output signals of the paths are cancelled (or removed) from the output terminal. Such cancellation at the output terminal reduces noise, such that a noise figure of a system is improved. In addition, this technology has a smaller number of constituent components as compared to other interference cancellation technologies, resulting in noise reduction.

3) Linearity Improvement

In accordance with the implementation of the multiple-input cancellation technology, undesired harmonic waves are restricted, such that not only linearity of the interference canceller but also the system linearity can be improved.

4) Multiple-path Cancellation

The structure according to this embodiment includes a plurality of independent paths. Therefore, the feed-forward cancellation technique may be considered to be ideal. The above-mentioned structure can be adapted to replace a coupler of the adaptive-null topology with an on-chip structure.

5) Gain Improvement

Provided that input signals of the LNA including a multiple-input interference canceller are differential, the LNA may also be used as a differential amplifier. The resultant structure may be helpful to gain improvement at the output end, such that the above-mentioned structure may also be used as a gain-increasing LNA.

As is apparent from the above description, the low noise amplifier (LNA) for use in the front end according to the embodiments of the present invention can remove interference- and noise-components from RF signals without performing frequency conversion, and can restrict the occurrence of undesired harmonic waves, such that linearity of the interference canceller and the system linearity can be improved.

While the present invention has been described with respect to the specific embodiments, it will be apparent to those skilled in the art that various changes and modifications may be made without departing from the spirit and scope of the invention as defined in the following claims.

What is claimed is:

1. A low noise amplifier for use in a front end comprising:
a multiple-input interference canceller configured to receive a plurality of input signals, and output a signal from which an interference component is removed,
wherein the multiple-input interference canceller includes:
a plurality of gain control blocks configured to receive each of the input signals, and perform gain control, and
a coupling block configured to couple output signals of the gain control blocks.

2. The low noise amplifier of claim 1, wherein the input signals are differential or independent signals.

3. The low noise amplifier of claim 1, wherein the gain control blocks have mutually-dependent gain values or independent gain values.

4. The low noise amplifier of claim 1, wherein each of the gain control blocks includes:
a pull-down unit for pulling down an output terminal in response to each input signal; and
a pull-up unit for pulling up the output terminal.

5. The low noise amplifier of claim 4, wherein each of the gain control blocks further includes:
an input potential controller that is connected between an input terminal receiving each input signal and an external power source so as to control potential of an input terminal.

6. The low noise amplifier of claim 5, wherein the input potential controller includes:
a first resistor connected to the external power source;
an NMOS diode connected between the first resistor and a ground terminal; and
a second resistor connected between the input terminal and a gate terminal of the NMOS diode.

7. The low noise amplifier of claim 4, wherein the output terminals of the gain control blocks are commonly connected to a final output terminal of the multiple-input interference canceller.

8. The low noise amplifier of claim 4, wherein each of the gain control blocks further includes:
a capacitor connected to a gate terminal of the pull-down unit and a ground terminal so as to perform potential maintenance or buffering operation.

9. The low noise amplifier of claim 1, wherein the coupling block is an adder or a subtractor.
